(19) United States
(12) Patent Application Publication
(10) Pub. No.: US 2014/0073434 A1
(43) Pub. Date: Mar. 13, 2014

(54) GAME PROVIDING DEVICE

(71) Applicant: DeNA Co., Ltd., Tokyo (JP)

(72) Inventor: Shinnosuke YUKISHITA, Tokyo (JP)

(73) Assignee: DeNA Co., Ltd., Tokyo (JP)

(21) Appl. No.: 14/021,922

(22) Filed: Sep. 9, 2013

(30) Foreign Application Priority Data
Sep. 13, 2012 (JP) 2012-201471

(51) Int. Cl. A63F 13/12

(52) U.S. Cl. CPC A63F 13/12
USPC 463/42

(57) ABSTRACT

One object of the present invention is to enhance the playability of a game in which a plurality of players try to fulfill a common game target such that more players actively participate the game. In accordance with one aspect, the value of a reinforcement parameter is increased when an elapsed time after the previous action was performed does not exceed a predetermined time period, and the player performing the current action is different from the player performing the previous action. That is, when a player performs an action within a predetermined time period after the previous action was performed by a different player, the team is provided with an increased reinforcement parameter value. A reinforcement parameter is increased with an increase range, calculated by multiplying the points committed by the player for the current action performance request by an adjustment factor corresponding to the progress of the game.

### CROSS-REFERENCE TO RELATED APPLICATIONS

This application is based on and claims the benefit of priority from Japanese Patent Application Serial No. 2012-201471 (filed on Sep. 13, 2012), the contents of which are hereby incorporated by reference in their entirety.

### TECHNICAL FIELD

The present invention relates to a game providing device, particularly to a game providing device for providing a game in which each of a plurality of players communicatively connected performs a predetermined action so as to fulfill the game target of a team constituted by the plurality of players.

### BACKGROUND

Conventionally known such game providing devices include game servers for providing online games played by players connected via a network such as the Internet by using communication terminals such as mobile phones, smart phones, personal computers, and gaming consoles. These game servers provide games in which players communicate and cooperate with each other, as represented by social games provided on social networking service (SNS) (see, for example, Japanese Patent Application Publication No. 2010-269073).

However, in these games in which players cooperate with each other to fulfill a common game target, there is a case where only a small number of players contribute to fulfillment of the game target and communication between players is not sufficiently enjoyable. When a plurality of players cooperatively play a game in which the players battle with virtual characters by using their own electronic cards, attacks made by part of the players owning strong cards are significantly effective; and relatively weak players owning only less strong cards tend to be less active. Thus, it is desired to eliminate the participation barrier against the relatively weak players and allow a larger number of players to actively participate the games and communicate with each other more actively, by enhancing the playability of the games cooperatively played by a plurality of players.

### SUMMARY

One object of the present invention is to enhance the playability of a game in which a plurality of players try to fulfill a common game target such that a larger number of players actively participate the game. Other objects of the present invention will be clarified by reference to the entire description in this specification.

A game providing device according to an embodiment of the present invention is a game providing device for providing a game in which each of a plurality of players communicatively connected performs a predetermined action so as to fulfill the game target of a team constituted by the plurality of players, the device comprising: a storage unit configured to store a second parameter shared by the plurality of players, the second parameter being used to reinforce a first parameter used to perform the predetermined action; a receiving unit configured to receive from the player a performance request for the predetermined action and information specifying the first parameter used to perform the predetermined action; a performing unit configured to reinforce the first parameter specified by the received information by using the second parameter stored in the storage unit and to perform the predetermined action; and an updating unit configured to update the second parameter based on progression of the game so as to increase an extent of reinforcement of the first parameter when the predetermined action is performed by the player to fulfill one or more predetermined conditions.

A method according to an embodiment of the present invention is a method for causing a computer to serve as a game providing device for providing a game in which each of a plurality of players communicatively connected performs a predetermined action so as to fulfill a game target of a team constituted by the plurality of players, the computer being capable of accessing a storage unit for storing a second parameter for reinforcing a first parameter used for performing a predetermined action, the second parameter being shared by the plurality of players, the method comprising the steps of: receiving from the player a performance request for the predetermined action and information specifying the first parameter used to perform the predetermined action; reinforcing the first parameter specified by the received information by using the second parameter stored in the storage unit and performing the predetermined action; and updating the second parameter based on progression of the game so as to increase an extent of reinforcement of the first parameter when the predetermined action is performed by the player to fulfill one or more predetermined conditions.

Various embodiments of the present invention enhance the playability of a game in which a plurality of players try to fulfill a common game target such that a larger number of players actively participate the game.

### BRIEF DESCRIPTION OF THE DRAWINGS

FIG. 1 is a block diagram schematically illustrating a game system including a server device according to an embodiment of the present invention.

FIG. 2 is a block diagram schematically illustrating the architecture of a terminal device connected to the server device according to the embodiment of the present invention.

FIG. 3 is a block diagram illustrating the functionality of the server device according to the embodiment of the present invention.

FIG. 4 shows an example of team management table according to the embodiment of the present invention.

FIG. 5 shows an example of player management table according to the embodiment of the present invention.

FIG. 6 shows an example of action history management table according to the embodiment of the present invention.

FIG. 7 is a flow diagram showing a game process according to an embodiment of the present invention.

FIG. 8 shows an example of a game screen displayed on the terminal device in the embodiment of the present invention.

FIG. 9 shows examples of adjustment factor 1 set in accordance with elapsed time of the game according to the embodiment of the present invention.

FIG. 10 shows examples of adjustment factor 2 set in accordance with the number of players performing actions in the embodiment of the present invention.

### DESCRIPTION OF EXAMPLE EMBODIMENTS

Various embodiments of the present invention will be described hereinafter with reference to the drawings. In the drawings, the same components are denoted by the same reference numerals.

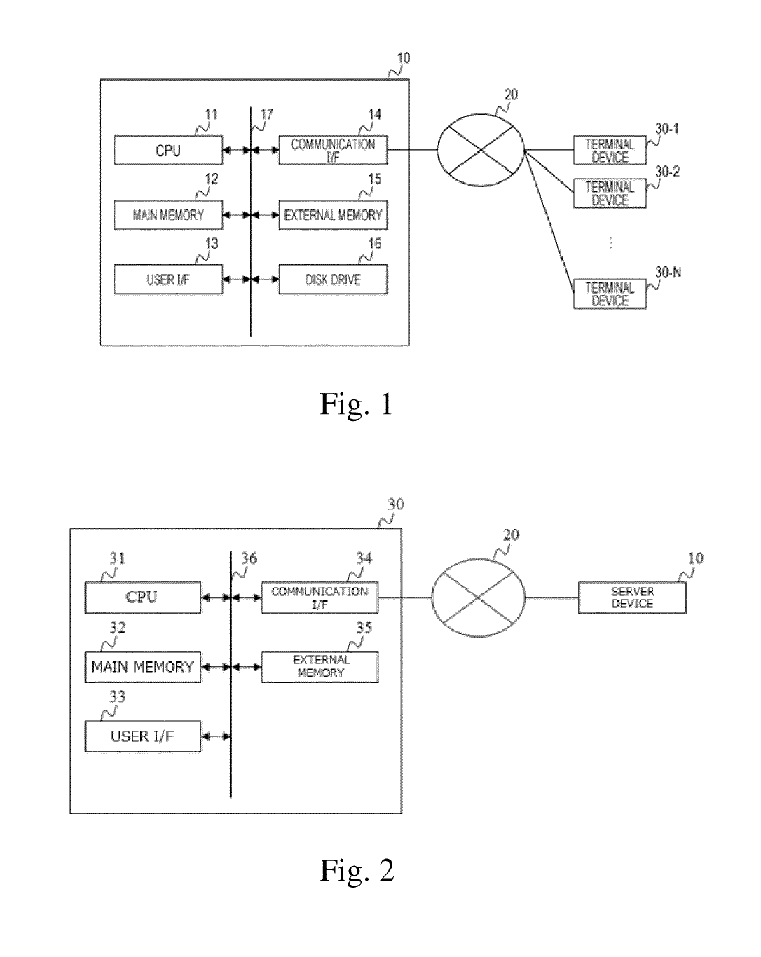

FIG. 1 is a block diagram schematically illustrating a game system including an online game server device 10 serving as a game providing device according to an embodiment of the present invention. As illustrated in FIG. 1, an online game server device 10 (hereinafter also referred to simply as the “server device 10”) may be communicatively connected to a plurality of terminal devices 30-1, 30-2, . . . , and 30-N (hereinafter also collectively referred to as the “terminal devices 30”), each having a communication function, via a communication network 20 such as the Internet.

As illustrated in FIG. 1, the server device 10 may include a central processing unit (CPU) 11, a main memory 12, a user interface (I/F) 13, a communication I/F 14, an external memory 15, and a disk drive 16, and these components may be electrically connected to one another via a bus 17. The CPU 11 may load an operating system and various programs for controlling the progress of an online game into the main memory 12 from the external memory 15, and may execute commands included in the loaded programs. The main memory 12 may be used to store a program to be executed by the CPU 11, and may be formed of, for example, a dynamic random access memory (DRAM).

The user I/F 13 may include, for example, an information input device such as a keyboard or a mouse for accepting an input from an operator, and an information output device such as a liquid crystal display for outputting calculation results of the CPU 11. The communication I/F 14 may be implemented as hardware, firmware, or communication software such as a transmission control protocol/Internet protocol (TCP/IP) driver or a point-to-point protocol (PPP) driver, or a combination thereof, and may be configured to be able to communicate with the terminal devices 30 via the communication network 20.

The external memory 15 may be formed of, for example, a magnetic disk drive and store various programs such as a control program for controlling the progress of an online game. The external memory 15 may also store various data used in the game. The various data that may be stored in the external memory 15 may also be stored on a database server communicatively connected to the server device 10 and physically separate from the server device 10. The disk drive 16 may read data stored in a storage medium such as a compact disc read only memory (CD-ROM), digital versatile disc read only memory (DVD-ROM), or DVD Recordable (DVD-R) disc, or writes data to such a storage medium. For example, a game application and data such as game data stored in a storage medium may be read by the disk drive 16, and may be installed into the external memory 15.

In an embodiment, the server device 10 may be a web server for managing a web site including a plurality of hierarchical web pages and may be capable of providing the terminal devices 30 with game services. The terminal devices 30 may fetch HTML data for rendering a web page from the server device 10 and analyze the HTML data to present the web page to a user (a player of the game) of the terminal devices 30. A game provided through such a web page is sometimes called a browser game. The HTML data for rendering the web page may also be stored on the external memory 15. HTML data may comprise HTML documents written in markup languages such as HTML; the HTML documents may be associated with various images. Additionally, the HTML documents may include programs written in script languages such as ActionScript™ and JavaScript™

The external memory 15 may store game applications to be executed on execution environments of the terminal device 30 other than browser software. This game application may include game programs for performing a game and various data such as image data to be referred to for executing the game programs. The game programs may be created in, for example, object oriented languages such as Objective-C™ and Java™. The created game programs may be stored on the external memory 15 in the form of application software along with various data. The application software stored on the external memory 15 may be delivered to a terminal device 30 in response to a delivery request. The application software delivered from the server device 10 may be received by the terminal device 30 through a communication I/F 34 in accordance with the control of CPU31; the received game programs may be sent to an external memory 35 and stored thereon. The application software may be launched in accordance with the player's operation on the terminal device 30 and may be executed on a platform implemented on the terminal device 30 such as NgCore™ or Android™. The server device 10 may provide the game applications executed on the terminal devices 30 with various data required for progression of the games. Additionally, the server device 10 can store various data sent from the terminal device 30 for each player, thereby managing the progression of the game for each player.

Thus, the server device 10 may manage the web site for providing game services and deliver web pages constituting the web site in response to a request from the terminal device 30, thereby progressing the game. Also, the server device 10 can progress a game by communicating with a game application performed on the terminal device 30 in place of, or in addition to, such a browser game. Whichever mode may be taken to provide the game, the server device 10 can store data required to progress the game for each identification identifying a player. The server device 10 may also include a function to authenticate a player at start of the game and perform charging process in accordance with progression of the game. The games provided by the server device 10 may include desired games such as action games, role playing games, interactive baseball games, and card games. The types of the games implemented by the web site or game applications of the server device 10 are not limited to those explicitly described herein.

In an embodiment, the terminal device 30 may be a desired information processing device capable of rendering, on a web browser, web pages of a game web site fetched from the server device 10; for example, the terminal device 30 may be a mobile phone, smart phone, game console, personal computer, touch pad, or electronic book reader, but is not limited thereto. In another embodiment, the terminal device 30 may be a desired information processing device including an application execution environment for executing a game application.

The architecture of the terminal device 30 will be described with reference to FIG. 2. FIG. 2 is a block diagram schematically illustrating the architecture of a terminal device 30. As illustrated in FIG. 2, the terminal device 30 may include a central processing unit (CPU) 31, a main memory 32, a user interface (I/F) 33, a communication I/F 34, and an external memory 35, and these components may be electrically connected to one another via a bus 36.

The CPU 31 may load various programs such as an operating system into the main memory 32 from the external memory 35, and may execute commands included in the loaded programs. The main memory 32 may be used to store a program to be executed by the CPU 31, and may be formed of, for example, a dynamic random access memory (DRAM).

The user I/F 33 may include, for example, an information input device such as a touch panel, a keyboard, a button, and a mouse for accepting an input from a player (user), and an information output device such as a liquid crystal display for outputting calculation results of the CPU 31. The communication I/F 34 may be implemented as hardware, firmware, or communication software such as a transmission control protocol/Internet protocol (TCP/IP) driver or a point-to-point protocol (PPP) driver, or a combination thereof, and may be configured to be able to communicate with the server devices 10 via the communication network 20.

The external memory 35 may comprise, for example, a magnetic disk drive or a flash memory and store various programs such as an operating system. When receiving a game application from the server device 10 via the communication I/F 34, the external memory 35 may store the received game application.

A terminal device 30 having such an architecture may include browser software for interpreting and rendering an HTML file (HTML data) for example; this browser software may enable the terminal device 30 to interpret the HTML data fetched from the server device 10 and render web pages corresponding to the received HTML data. Further, the terminal device 30 may include plug-in software (e.g., Flash Player distributed by Adobe Systems Incorporated) embedded into browser software; therefore, the client device 30 can fetch from the server device 10 a SWF file embedded in HTML data and execute the SWF file by using the browser software and the plug-in software.

When a game is executed on the terminal device 30, for example, animation or an operation icon designated by the program may be displayed on a screen of the terminal device 30. The player may enter an instruction for causing the game to progress using an input interface (e.g., a touch screen or a button) of the terminal device 30. The instruction entered by the player may be transmitted to the server device 10 through the browser of the terminal device 30 or a platform function such as NgCore™.

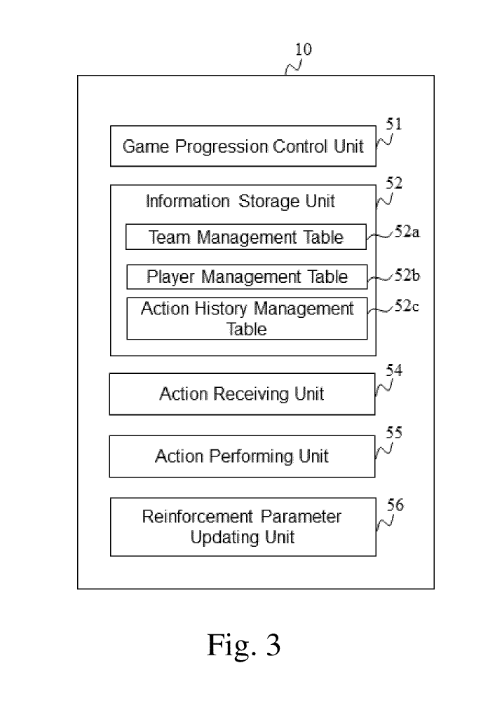

Next, the functionality of the server device 10 implemented by the components shown in FIG. 1 will now be described. As stated above, the server device 10 may provide various games including a cooperation game in which a plurality of players try to fulfill a common game target; this game is suited to description of the present invention. Hereinafter, the description is focused on the embodiment of server device 10 that provides the cooperation game. FIG. 3 is a block diagram illustrating the functionality of a server device 10 according to an embodiment of the present invention. As shown in the figure, the server device 10 according to this embodiment may comprise: a game progression control unit 51 for controlling progress of a game; an information storage unit 52 for storing various tables to be used in progress of the game; an action receiving unit 54 for receiving a performance request for an action via the terminal device 30 from a player; an action performing unit 55 for performing the received action; and a reinforcement parameter updating unit 56 for updating the value of a reinforcement parameter used in the cooperation game. The reinforcement parameters will be described later. These functions may be implemented through cooperation between the CPU 11 and programs, tables, and the like stored in the main memory 12 and the external memory 15.

The game progression control unit 51 may send and receive various data required for the progression of the game to and from the terminal device 30 and manage such data for each player, thereby controlling the progression of the game for each player. For example, the game progression control unit 51 can sequentially display, on the terminal device 30, web pages constituting a web site for providing game services in response to a request from the terminal device 30. When a hyperlink on the displayed web page is selected by the player, the game progression control unit 51 may send new HTML data corresponding to the hyperlink to the terminal device 30. The terminal device 30 may display a web page based on the new HTML data. Thus, the game progression control unit 51 may control the game such that web pages stored on the server device 10 are sequentially provided to the terminal device 30 in accordance with the operation by the player; and the player can progress the game by his own operation through the function of the game progression control unit 51.

When the terminal device 30 executes the game application, the game progression control unit 51 can send various data used in the game to the game application. For example, when receiving from a game application on the terminal device 30 a control signal indicating that a certain mission has been fulfilled, the game progression control unit 51 may provide the game application with various parameters related to a mission subsequent to the fulfilled mission. The game application may load the data provided by the server device 10 and progress the game.

The terminal device 30 can appropriately send to the server device 10 various information on progression of the game such as information indicating various parameter values used in the game (information on earned game points and earned items) and information indicating a status (information specifying a fulfilled mission), through the function of browser software or the game application. The game progression control unit 51 may store, for each player, information on the progression of the game received from a plurality of terminal devices 30, thereby controlling the progression of the game for each player. Thus, when the player logs in the server device 10 using his own ID, the game may be resumed from the stage corresponding to the progression of the player (e.g., the stage where the game was interrupted) based on the information on the progression of the game associated with the player stored in the server device 10. The information required for the progression of the game may also be managed by various functions of the server device 10 other than the game progression control unit 51.

The information storage unit 52 may store tables to be used to progress the cooperation game: a team management table 52a for managing information on teams each constituted by a plurality of players participating the cooperation game, a player management table 52b for managing information on the players, and an action history management table 52c for managing history of actions performed by the players.

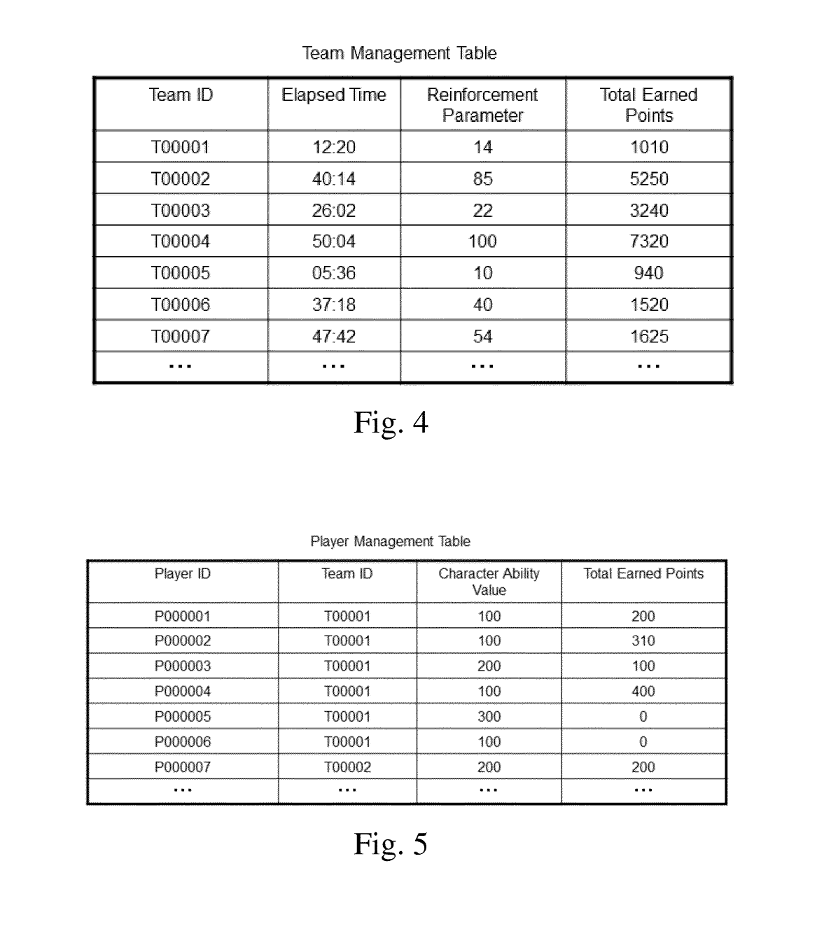

FIG. 4 illustrates an example of the team management table 52a. As shown in the figure, the team management table 52a may store, in association with “team ID” identifying a team, information such as “elapsed time” indicating an elapsed time after the team started the game, “reinforcement parameter” indicating the value of the reinforcement parameter commonly used by players belonging to the team, and “total earned points” indicating the total points earned by the players belonging to the team.

FIG. 5 illustrates an example of the player management table 52b. As shown in the figure, the player management table 52b may store, in association with “player ID” identifying a player, information such as “team ID” of the team including the player, “character ability value” indicating the ability value of a character corresponding to the player, and “total earned points” indicating the total points earned by the player. A character refers to an electronic character that is a game content to be used in the game; and a character may be used by a player performing an action in a cooperation game. Further, characters may be assigned to players at a start of a cooperation game; and the ability values of the characters may be set to an initial value common to the players at a start of the game. The characters will be further descried later.

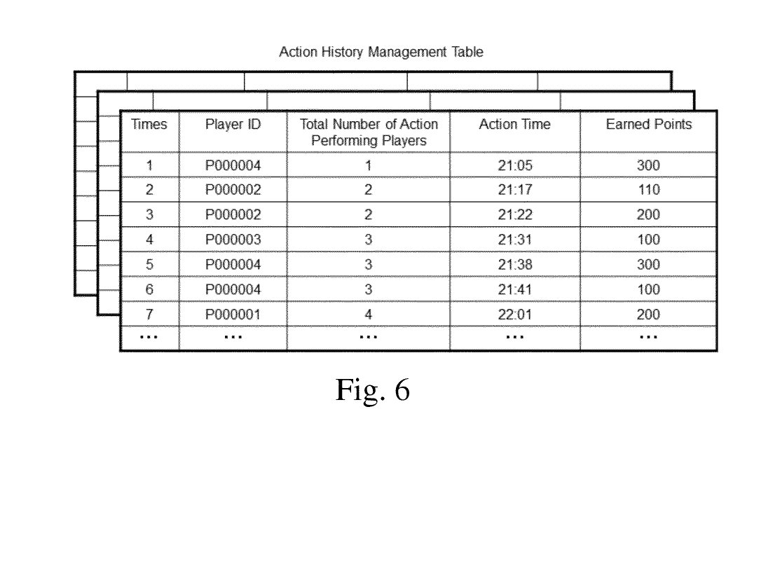

FIG. 6 illustrates an example of the action history management table 52c. As shown in the figure, the action history management table 52c may store, in association with “number of times” indicating the number of actions (history) performed by the team after the game was started, “player ID” of a player who performed the action for the time, “total number of action performing players” indicating the total number of players in the team who performed actions, “action time” indicating the time when the action was performed for the time, and “earned points” indicating the points earned by the player in an action for the time. It should be noted that the “total number of action performing players” may not be a cumulative total but a summarized total without duplication of a player who performed actions a plurality of times. In the example shown in FIG. 6, it was explained that history of actions by one team may be managed; but actually, since the server device 10 may provide a cooperation game to a plurality of teams, the action history management table 52c may manage action history of a plurality of teams involved in a cooperation game.

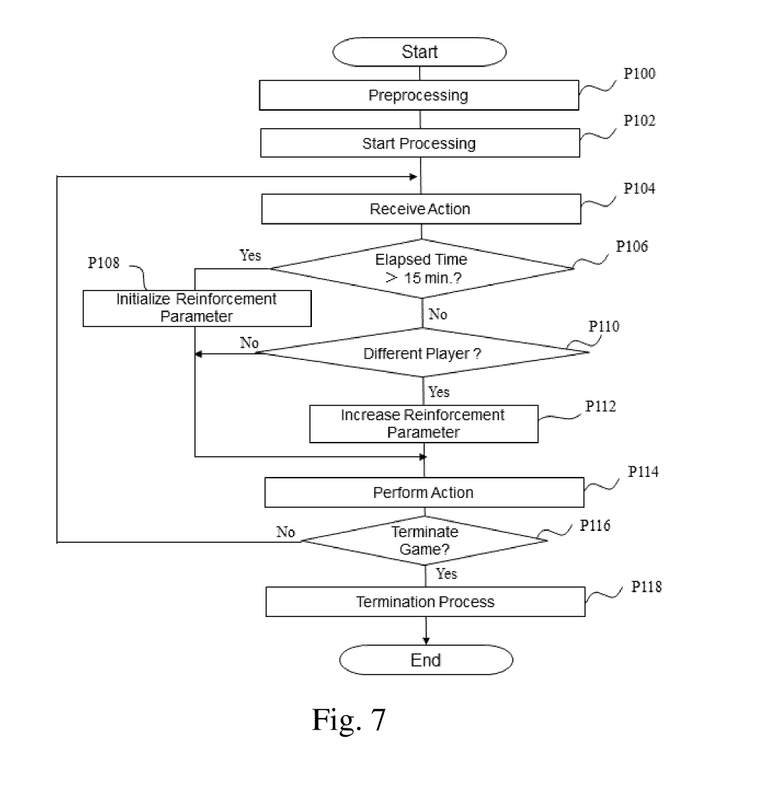

Next, operations of such a server device 10 as an embodiment of the present invention will now be described. FIG. 7 is a flow diagram showing an example of a game processing performed by the server device 10. In the game processing, preprocessing may be first executed, in which various processes required before a game is started are performed (step P100). Examples of the various processes performed in the preprocessing may include a process to provide data notifying a start of a cooperation game to the terminal device 30 of a player who is playing another game provided by the server device 10, a process to receive a registration of participation to the cooperation game from the terminal device 30, and a process to receive data that requests organization of a team from the terminal devices 30 of individual players and manage the organization of the team. Briefly, organization of a team may be managed so as to create a record in the team management table 52a and set the “team ID” of the player management table 52b to the “team ID” of the team including the players.

Next, if a condition to start the game is satisfied, start processing may be executed, in which various processes required to start the game are performed (step P102). The condition to start the game may be, for example, that the time preset by a game provider providing the game comes, or that a specific event occurs in another game played by any of the players constituting the team. Examples of the various processes performed in the start processing may include a process to provide data notifying a start of the game to the terminal devices 30 of the players previously registered as participants and a process to make a setting so that a main screen, described later, of the game can be provided to the terminal devices 30 of the players.

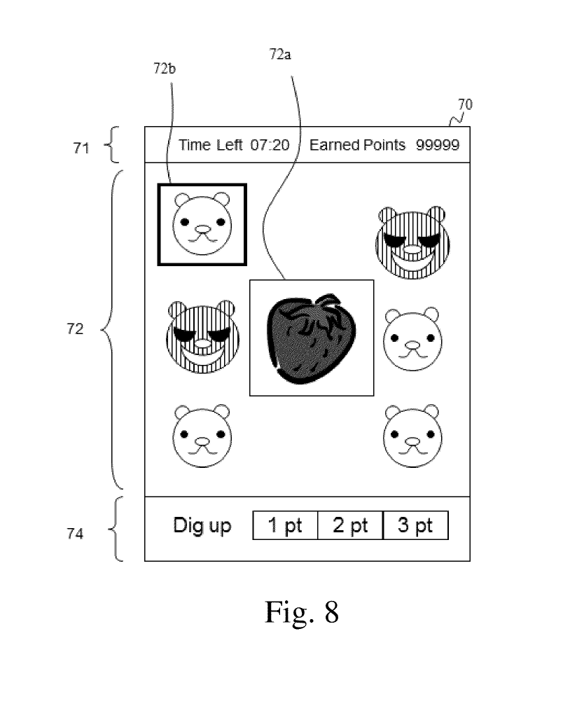

The main screen 70 used as a basic screen for playing the game illustrated in FIG. 8 will now be described along with the content of the cooperation game. As described above, when the start processing in step P102 is executed, the main screen 70 can be provided to the terminal device 30 of each player (i.e., the main screen 70 becomes accessible to the terminal device 30). As shown, the main screen 70 may include the following sections arranged from top to bottom: a basic information display section 71 for displaying remaining time of the game and the points earned by the team; a situation display section 72 for displaying animation, etc. decoratively representing the situation of the cooperation game; and an action performance request section 74 where the player requests performance of an action. As shown, the situation display unit 72 may display an image of a crop (e.g., a strawberry) in the middle area 72a and images of characters (e.g., bears) corresponding to the players participating the cooperation game around the middle area 72a. A character corresponding to the player operating the terminal device 30 displaying the main screen 70 may be displayed in the upper left portion (72b) of the situation display section 72, and the characters corresponding to other players may be randomly displayed in other portions. As described above, the ability values of the characters may be set to a same initial value for each player at the time of starting the game; but the players can increase the ability value of the character corresponding to himself by using an item, etc. The situation display section 72 of the main screen 70 may display the characters in different appearances depending on their ability values. As shown, the action performance request section 74 may allow a player to select the points to be committed from “1pt,” “2pt,” and “3pt”; the player selecting the points can simultaneously request the performance of an action and select the points to be committed.

In the cooperation game with thus configured main screen 70 used as a basic screen, players in a team may cause corresponding characters to perform “dig-up” action on a crop displayed in the middle area 72a of the situation display section 72; and the game target of the team is to complete digging of the crop within a time limit. The “dig-up power” of a character may be determined based on the above-mentioned ability value of the character, the points selected through the action performance request section 74 of the main screen 70, and the reinforcement parameters described above; and the crop may be dug up with the determined “dig-up power.” When the crop is dug up, players may obtain points corresponding to the “dig-up power,” and the crop may be dug up to the extent corresponding to the obtained points. That is, when the total of the points obtained by the players in the team reaches predetermined points, digging of the crop has been completed and the game target has been fulfilled.

Referring back to the flow diagram shown in FIG. 7, the start processing in step P102 may be executed, and then action performance requests may be received from the terminal devices 30 of the players (step P102). As described above, the action performance requests may be made when players operate the action performance request section 74 of the main screen 70 displayed on the terminal device 30. When a player selects points to be committed through the action performance request section 74, the data specifying the selected points may be sent from the terminal device 30 and received by the server device 10. Further, as described above, the server device 10 may manage, for each player, data sent/received between the server device 10 and the terminal devices 30 under control of the game progression control unit 51; therefore, the server device 10 may specify “player ID” of the player who sent the data specifying the points.

After receiving the data specifying the point from the terminal device 30, the server device 10 may perform a series of processes for updating the reinforcement parameters in accordance with the elapsed time after the previous action was performed and the comparison with the player who performed the previous action (steps P106-P112). First, the server device 10 may determine whether or not the elapsed time after the previous action was performed exceeds the predetermined time (e.g., 15 minutes) (step P106); and if positive, the server device 10 may initialize the reinforce parameters (step P108). The elapsed time after the previous action was performed may be calculated as the difference between the current time and the “action time” of the previous action performance (the newest action performance) managed in the action history management table 53c. The reinforcement parameter may increase the “dig-up power” of a player performing an action (causing the character to dig up the crop). In this example, the “dig-up power” may be multiplied by “1+0.05× the value of the reinforcement parameter.” That is, when the reinforcement parameter is increased by 1, the magnification for reinforcing the “dig-up power” may be increased by 5%. Additionally, the reinforcement parameter may be initially set to zero; in this case, the “dig-up power” may remain unmultiplied (not reinforced). As described above, a reinforcement parameter may be stored in the team management table 52a in association with “a team ID.” Specifically, the processing for initializing the reinforcement parameter may involve update of the team management table 52a such that the value of the reinforcement parameter corresponding to the “team ID” (managed in the player management table 52b) of the team including the player may be rendered zero. Additionally, for the first action in the game, no “previous action performance” exists in step P106. In this case, it may be always determined that the elapsed time exceeds the predetermined time, and the processing may proceed to initialization of the reinforcement parameter.

When the server device 10 determines in step P106 that the elapsed time after the previous action was performed does not exceed the predetermined time, the server device 10 may then determine whether the player who currently performs an action is different from the player who previously performed an action (step P110); if the current player is different from the previous player, the server device 10 may increase the value of the reinforcement parameter (step P112). That is, when a player performs an action within a predetermined time after the previous action was performed by a different player, the team may be provided with a benefit of increased reinforcement parameter value. The comparison with the previous player may involve comparison with the “player ID” of the previous action performance (the newest action performance) managed in the action history management table 52c.

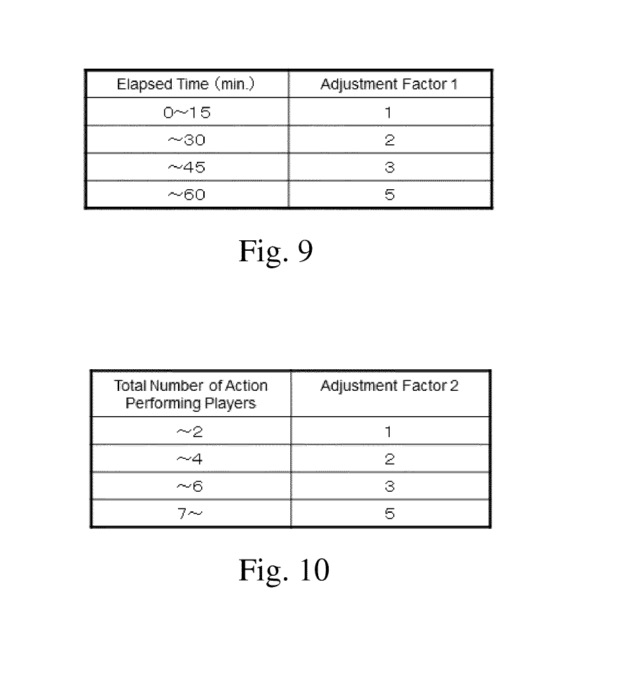

The processing for increasing the value of a reinforcement parameter will now be described in detail A reinforcement parameter may be increased with an increase range, which is calculated by multiplying the points committed by the player for the current action performance request by an adjustment factor corresponding to the progress of the game. This embodiment may use the following adjustment factors: adjustment factor 1 corresponding to the elapsed time of the game, and adjustment factor 2 corresponding to the total number of action performing players. As described above, the total number of action performing players may refer to the total number of players in a team who performed actions after the game was started FIG. 9 shows examples of setting of adjustment factor 1. As in examples shown in FIG. 9, adjustment factor 1 may be larger with the length of the elapsed time of the game; as a result, the increase range of the reinforcement parameter may be larger with the length of the elapsed time of the game (as it comes to a later stage of the game). FIG. 10 shows examples of setting of adjustment factor 2. As in examples shown in FIG. 10, adjustment factor 2 may be larger with the total number of action performing players; as a result, the increase range of the reinforcement parameter may be larger with the total number of action performing players. For example, if a player commits “1pt” for a current action performing request, and the elapsed time of the game is “10 minutes,” and the total number of action performing players is “3,” then adjustment factor 1 may be “1’ (see FIG. 9) and adjustment factor 2 may be “2” (see FIG. 10). As a result, the increase range of the reinforcement parameter may be 1 (point)×1 (adjustment factor 1)×2 (adjustment factor 2)=“2.” Additionally, for example, if a player commits “2pt” for a current action performing request, and the elapsed time of the game is “35 minutes,” and the total number of action performing players is “8,” then adjustment factor 1 may be “3’ (see FIG. 9) and adjustment factor 2 may be “5” (see FIG. 10). As a result, the increase range of the reinforcement parameter may be 2 (points)×3 (adjustment factor 1)×5 (adjustment factor 2)=“30.” Thus, the increase range of the reinforcement parameter may be larger as more points are committed by the player, the elapsed time of the game is longer, and the total number of action performing players is larger. This may encourage players to commit more points, perform an action at a later stage of the game, and urge other players to perform an action, thereby to enhance the playability in cooperation games. Specifically, the processing for increasing the reinforcement parameter may involve update of “reinforcement parameter” in the team management table 52a so as to add the calculated increase range to the value of the reinforcement parameter corresponding to the “team ID” (managed in the player management table 52b) of the team including the player.

After thus performing a series of processing for updating the reinforcement parameter based on the elapsed time after the previous action was performed and the comparison with the player who performed the previous action, the server device 10 may subsequently perform an action currently received (step P114). As described above, an action to be performed may be digging of a crop performed by a character corresponding to the player, wherein the situation display section 72 of the main screen 70 displayed on the terminal device 30 of the player may display an animation in which the character digs up the crop, and the “dig-up power” of the character may be calculated to provide points to the player. The “dig-up power” may be calculated by multiplying the “character ability value” corresponding to the player (managed in the player management table 52b) by a magnification corresponding to the points committed by the player (in this example, 1pt, 2pt, and 3pt correspond to magnifications of 1, 2, and 3, respectively), and further multiplying by a magnification corresponding to the value of the reinforcement parameter (in this example, 1+the reinforcement parameter×0.05, as described above). For example, if the “character ability value” is “100,” the committed points are “2pt,” and the value of the reinforcement parameter is “14,” then the “dig-up power” of the character is 100×3×(1+14×0.05)=510. The player may obtain the same number of points as the value of the “dig-up power.” When an action is performed, a record corresponding to the current action may be created in the action history management table 52c; the record may contain “player ID” of the player who performed the current action, and the current “total number of action performing players,” “action time,” and “earned points.” The “earned points” may be set to the calculated “dig-up power” of the character. Likewise, the “dig-up power” may be added to the “total earned points” in the player management table 52b and may also be added to the “total earned points” in the team management table 52a.

Then, it may be determined whether the game termination condition is fulfilled (step P116). Until the condition is fulfilled, the processing may repeatedly receive action performance requests from players, update the reinforcement parameters, and perform the received action. In this example, the game termination condition may be that the elapsed time after the game was started reaches a predetermined time (e.g., 60 minutes) or that the “total earned points” of the team (managed in the team management table 52a) reaches predetermined points (e.g., 10,000 points). When any one of the above is fulfilled, the game may be terminated. If the game termination condition is fulfilled, a termination process may be performed, in which various processes required to terminate the game may be performed (step P118); and the game processing may be terminated. The various processes performed in the termination process may include sending of a screen notifying the game result to the terminal devices 30. For example, when the crop has been dug up within a time limit (the total earned points of the team has reached the predetermined points), a screen notifying that the game target has been fulfilled may be sent to the terminal devices 30; and in contrast, when the crop has not been dug up within a time limit (the time limit has been elapsed before the total earned points of the team reaches the predetermined points), a screen notifying that the game target has not been fulfilled may be sent to the terminal devices 30.

The embodiment of the present invention as described above is a cooperation game in which “dig-up” actions of a crop may be performed by the characters corresponding to the players in the team and the game target of a team may be to complete the digging of the crop within a time limit, wherein the reinforcement parameter for increasing the “dig-up power,” which may be common to the players in the team, may be increased in accordance with the elapsed time after the previous action was performed and the comparison with the player who performed the previous action, thereby to enhance the playability of the game in which a plurality of players may try to fulfill a common game target. Further, the increase range in increasing the reinforcement parameter may be adjusted with adjustment factor 1 corresponding to the elapsed time of the game, and adjustment factor 2 corresponding to the total number of action performing players; therefore, the players can expect the variation of the increase range of the reinforcement parameter in accordance with the progress of the game.

Additionally, in the embodiment of the present invention, players may have the ability values of the characters set to the same initial value at a start of the game; therefore, the game participation barrier against relatively weak players may be relieved.

In the embodiment, the server device 10 may increase the reinforcement parameter when the elapsed time after the previous action was performed has not reached the predetermined time and the player who performs the current action is different from the player who performed the previous action; however, the reinforcement parameter may also be increased when only one of these conditions is fulfilled, not both. Further, other conditions may be used for increasing the reinforcement parameter as long as related to performance of the actions. For example, the reinforcement parameter may be increased on the condition that the action is to be performed by a player having a character as a game content whose ability value is lower than a predetermined value. Thus, players having low-ability characters may be encouraged to participate the game actively.

In the embodiment, the server device 10 may calculate the increase range for increasing the reinforcement parameter by using adjustment factor 1 corresponding to the elapsed time of the game and adjustment factor 2 corresponding to the total number of action performing players; however, it may also be naturally possible to use only one of adjustment factors 1 and 2. Further, the increase range may also be calculated in accordance with game progress factors other than the elapsed time of the game and the total number of action performing players. For example, it may also be possible to calculate the increase range of the reinforcement parameter based on the number of times of performing the actions by the team after the game was started or to calculate the increase range of the reinforcement parameter based on the current total earned points of the team. These calculations of the increase range of the reinforcement parameter in accordance with the progress of the game may increase the playability of the game. Further, the points committed by the player may be multiplied by adjustment factors 1 and 2 described above; but this calculation is not essential. For example, a parameter value other than the points may also be multiplied by adjustment factors 1 and 2; or alternatively, the increase range itself may also be determined in accordance with the game progress factors such as the elapsed time of the game and the total number of action performing players, instead of the adjustment factors.

In the embodiment, the server device 10 may set the reinforcement parameter as a value that specifies the magnification (1+the reinforcement parameter×0.05) used to calculate the “dig-up power”; however, the magnification itself may also be used as a reinforcement parameter. Additionally, the reinforcement parameter may not necessarily be related to the magnification used to calculate the “dig-up power”; for example, the reinforcement parameter may also be set as a value to be added to the “dig-up power.”

In the embodiment, the server device 10 may calculate the “dig-up power” by using the reinforcement parameter to reinforce the value calculated by multiplying the “character ability value” corresponding to the player by the magnification corresponding to the points committed by the player; however, the reference value reinforced by the reinforcement parameter may not necessarily be calculated in this manner. For example, the reference value may be the character ability value only or the points committed by the player. Further, it may also be possible to use parameters other than the character ability value and the points committed by the player.

In the embodiment, the server device 10 may initialize the reinforcement parameter when the elapsed time after the previous action was performed exceeds a predetermined time; however, the server device 10 may also retain the current value without initialization.

Game contents are not limited to characters, which may be used in the embodiment as an example; game contents may include electronic cards, items, avatars, and all other types of electronic data used in games.

The processes and procedures described and illustrated herein may be implemented by software, hardware, or any combination thereof including those explicitly stated in the embodiments. More specifically, the processes and procedures described and illustrated herein may be implemented by the installation of the logic corresponding to the processes into a medium such as an integrated circuit, a volatile memory, a non-volatile memory, a magnetic disk, or an optical storage. The processes and procedures described and illustrated herein may also be installed in the form of a computer program, and executed by various computers.

Even if the processes and the procedures described in the specification are executed by a single apparatus, software piece, component, or module in the description, the processes and the procedures can be executed by a plurality of apparatuses, software pieces, components, and/or modules. Even if the data, tables, or databases described herein are stored in a single memory in the description, the data, tables, or databases may be dispersed and stored in a plurality of memories included in a single apparatus or in a plurality of memories dispersed and arranged in a plurality of apparatuses. The elements of the software and the hardware described herein can be integrated into fewer constituent elements or can be decomposed into more constituent elements.

With respect to the use of substantially any plural and/or singular terms herein, those having skill in the art can translate from the plural to the singular and/or from the singular to the plural as is appropriate to the context.

1. A game providing device for providing a game in which each of a plurality of players communicatively connected performs a predetermined action so as to fulfill the game target of a team constituted by the plurality of players, the device comprising:
a storage unit configured to store a second parameter shared by the plurality of players, the second parameter being used to reinforce a first parameter used to perform the predetermined action;
a receiving unit configured to receive from the player a performance request for the predetermined action and information specifying the first parameter used to perform the predetermined action;
a performing unit configured to reinforce the first parameter specified by the received information by using the second parameter stored in the storage unit and to perform the predetermined action; and
an updating unit configured to update the second parameter based on progression of the game so as to increase an extent of reinforcement of the first parameter when the predetermined action is performed by the player to fulfill one or more predetermined conditions,
wherein the updating unit updates the second parameter based at least on an elapsed time after the game was started as the progression of the game.

2. (canceled)

3. The game providing device of claim 1 wherein the updating unit updates the second parameter based at least on a number of players performing the predetermined action as the progression of the game.

4. The game providing device of claim 1 wherein the updating unit updates the second parameter on the one or more predetermined conditions, one of the one or more predetermined conditions being that the player performing the predetermined action is different from a player performing the predetermined action previously.

5. The game providing device of claim 1 wherein the updating unit updates the second parameter on the one or more predetermined conditions, one of the one or more predetermined conditions being that the predetermined action is performed within a predetermined time period after the predetermined action was performed previously.

6. The game providing device of claim 5 wherein the updating unit sets the second parameter to an initial value when the predetermined action is performed more than the predetermined time period after the predetermined action was performed previously.

7. The game providing device of claim 1 wherein the second parameter specifies a magnification for reinforcing the first parameter.

8. The game providing device of claim 7 wherein the updating unit updates the second parameter such that an increase range of the magnification is larger as an elapsed time after the game was started is longer.

9. The game providing device of claim 7 wherein the updating unit updates the second parameter such that an increase range of the magnification is larger as more players perform the predetermined action.

10. The game providing device of claim 1,
wherein the storage unit stores information on at least one game content owned by the player in association with the player, the information including an ability value of the game content, and
wherein the first parameter includes the ability value of the game content.

11. The game providing device of claim 10, wherein the ability values of the game contents are set to a same initial value for each of the plurality of players at least at a start of the game.

12. The game providing device of claim 1 wherein the first parameter includes points committed by the player.

13. The game providing device of claim 12 wherein the updating unit updates the second parameter based on the points committed by the player.

14. A computer-readable storage medium storing a program for causing a computer to serve as a game providing device for providing a game in which each of a plurality of players communicatively connected performs a predetermined action so as to fulfill a game target of a team constituted by the plurality of players, the computer being capable of accessing a storage unit for storing a second parameter for reinforcing a first parameter used for performing a predetermined action, the second parameter being shared by the plurality of players, the program causing the computer to perform the steps of:
receiving from the player a performance request for the predetermined action and information specifying the first parameter used to perform the predetermined action;
reinforcing the first parameter specified by the received information by using the second parameter stored in the storage unit and performing the predetermined action; and
updating the second parameter based on progression of the game so as to increase an extent of reinforcement of the first parameter when the predetermined action is performed by the player to fulfill one or more predetermined conditions,
wherein the updating step includes updating the second parameter based at least on an elapsed time after the game was started as the progression of the game.
